(19) United States
(12) Patent Application Publication
(10) Pub. No.: US 2008/0013933 A1
(43) Pub. Date: Jan. 17, 2008

(54) ANTI-SHAKE APPARATUS

(75) Inventor: Yukio Uenaka, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/775,887

(22) Filed: Jul. 11, 2007

(30) Foreign Application Priority Data
Jul. 13, 2006 (JP) 2006-192353

(51) Int. Cl. G03B 17/00; H04N 5/228

(52) U.S. Cl. 396/55; 348/208.11; 348/E05.031

(57) ABSTRACT

An anti-shake apparatus for image stabilizing comprises a movable unit and a controller. The movable unit is movable for an anti-shake operation. The controller moves the movable unit to a predetermined position over the course of a predetermined time length before the anti-shake operation commences. The controller moves the movable unit at a decelerated, low rate of speed before finishing its movement to the predetermined position. The anti-shake operation is performed after completion of the movement to the predetermined position.

### BACKGROUND OF THE INVENTION

1. Field of the Invention

The present invention relates to an anti-shake apparatus for a photographing apparatus, and in particular to the centering operation that moves the movable unit to the predetermined position before the anti-shake operation, with a stabilized movement.

2. Description of the Related Art

An anti-shake apparatus for a photographing apparatus is proposed. The anti-shake apparatus corrects for the hand-shake effect by moving a hand-shake correcting lens or an imaging device on a plane that is perpendicular to the optical axis, corresponding to the amount of hand-shake which occurs during imaging.

Japanese unexamined patent publication (KOKAI) No. H07-261233 discloses an apparatus that performs the centering operation that moves the movable unit to the center of the range of movement as the predetermined position before the anti-shake operation.

However, the detail of the movement control of the movable unit for the centering operation is not described. In the case that the movable unit is moved rapidly in the centering operation, the movement of the movable unit includes a swinging motion which may cause instability.

### SUMMARY OF THE INVENTION

Therefore, an object of the present invention is to provide an anti-shake apparatus (an image stabilizing apparatus) that can perform the centering operation with a stabilized movement.

According to the present invention, an anti-shake apparatus for image stabilizing comprises a movable unit and a controller. The movable unit is movable for an anti-shake operation. The controller moves the movable unit to a predetermined position over the course of a predetermined time length before the anti-shake operation commences. The controller moves the movable unit at a decelerated, low rate of speed before finishing its movement to the predetermined position. The anti-shake operation is performed after completion of the movement to the predetermined position.

### BRIEF DESCRIPTION OF THE DRAWINGS

The objects and advantages of the present invention will be better understood from the following description, with reference to the accompanying drawings in which:

FIG. 1 is a perspective rear view of the embodiment of the photographing apparatus viewed from the back side;

FIG. 2 is a front view of the photographing apparatus;

FIG. 3 is a circuit construction diagram of the photographing apparatus;

FIG. 4 is a flowchart that shows the main operation of the photographing apparatus;

FIG. 5 is a flowchart that shows the detail of the interruption process of the timer;

FIG. 6 is a figure that shows calculations in the anti-shake operation;

FIG. 7 is a graph that shows the relationship between an elapsed time and the distance between the movable unit and the center of the range of movement; and

FIG. 8 is a graph that shows the relationship between the elapsed time and the speed of the movable unit.

### DESCRIPTION OF THE PREFERRED EMBODIMENTS

The present invention is described below with reference to the embodiment shown in the drawings. In the embodiment, the photographing apparatus 1 is a digital camera. A camera lens 67 of the photographing apparatus 1 has an optical axis LX.

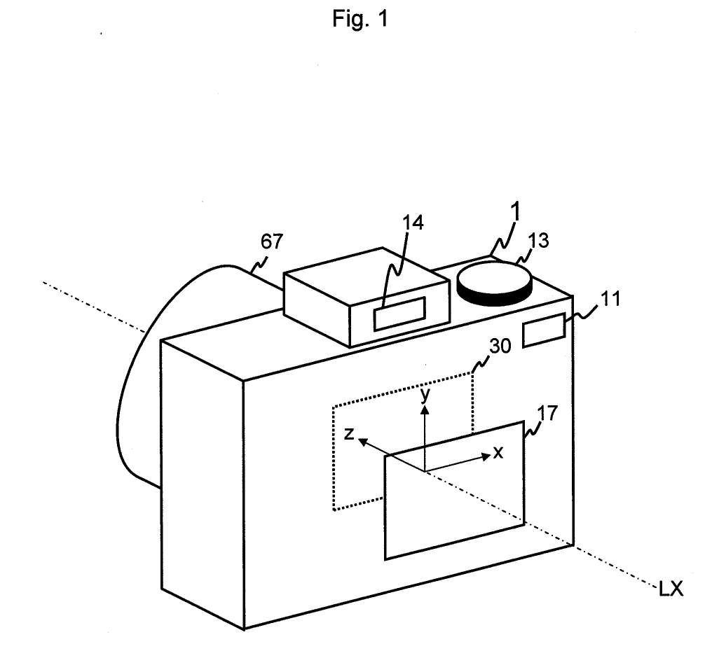

In order to explain the direction in the embodiments, a first direction x, a second direction y, and a third direction z are defined (see FIG. 1). The first direction x is a direction which is perpendicular to the optical axis LX. The second direction y is a direction which is perpendicular to the optical axis LX and the first direction x. The third direction z is a direction which is parallel to the optical axis LX and perpendicular to both the first direction x and the second direction y.

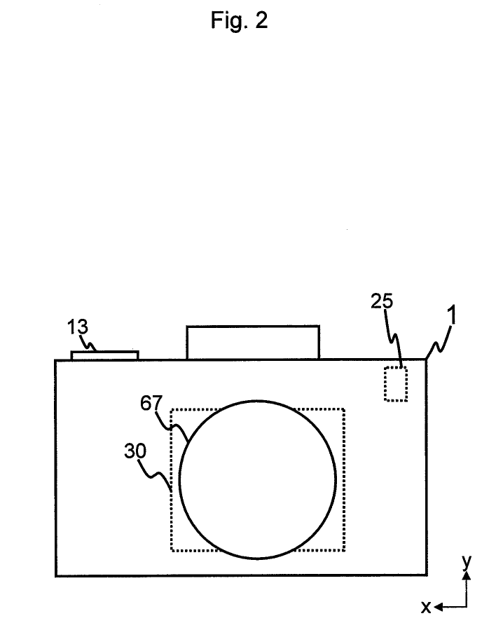

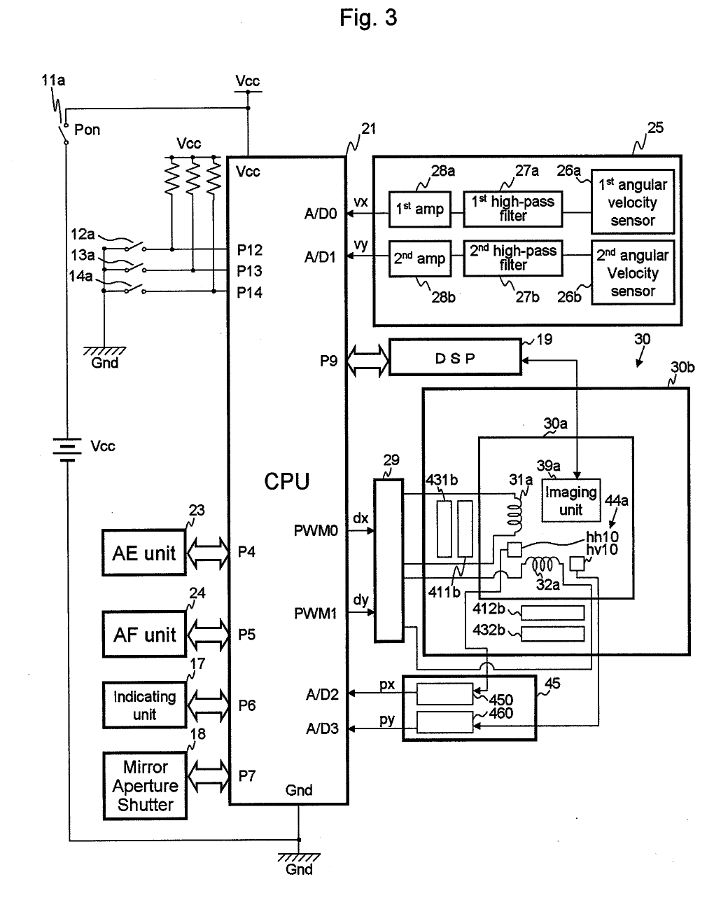

The imaging part of the photographing apparatus 1 comprises a PON button 11, a PON switch 11a, a photometric switch 12a, a release button 13, a release switch 13a, an anti-shake button 14, an anti-shake switch 14a, an indicating unit 17 such as an LCD monitor etc., a mirror-aperture-shutter unit 18, a DSP 19, a CPU 21, an AE (automatic exposure) unit 23, an AF (automatic focus) unit 24, an imaging unit 39a in the anti-shake unit 30, and a camera lens 67 (see FIGS. 1, 2, and 3).

Whether the PON switch 11a is in the ON state or the OFF state is determined by the state of the PON button 11, so that the ON/OFF states of the photographing apparatus 1 correspond to the ON/OFF states of the PON switch 11a.

The photographic subject image is captured as an optical image through the camera lens 67 by the imaging unit 39a, and the captured image is displayed on the indicating unit 17. The photographic subject image can be optically observed by the optical finder (not depicted).

When the release button 13 is partially depressed by the operator, the photometric switch 12a changes to the ON state so that the photometric operation, the AF sensing operation, and the focusing operation are performed.

When the release button 13 is fully depressed by the operator, the release switch 13a changes to the ON state so that the imaging operation by the imaging unit 39a (the imaging apparatus) is performed, and the image which is captured, is stored.

The mirror-aperture-shutter unit 18 is connected to port P7 of the CPU 21 and performs an UP/DOWN operation of the mirror (a mirror-up operation and a mirror-down operation), an OPEN/CLOSE operation of the aperture, and an OPEN/CLOSE operation of the shutter corresponding to the ON state of the release switch 13a.

The DSP 19 is connected to port P9 of the CPU 21, and it is connected to the imaging unit 39a. Based on a command from the CPU 21, the DSP 19 performs the calculation operations, such as the image processing operation etc., on the image signal obtained by the imaging operation of the imaging unit 39a.

The CPU 21 is a control apparatus that controls each part of the photographing apparatus 1 regarding the imaging operation and the anti-shake operation (i.e. the image stabilizing operation). The anti-shake operation includes both the movement of the movable unit 30a and position-detection efforts.

Further, the CPU 21 stores a value of the anti-shake parameter IS that determines whether the photographing apparatus 1 is in the anti-shake mode or not, a value of a release state parameter RP, a value of a mirror state parameter MP, a value of a mirror-up time parameter MRUP, and values of a first present position parameter PPx and a second present position parameter PPy.

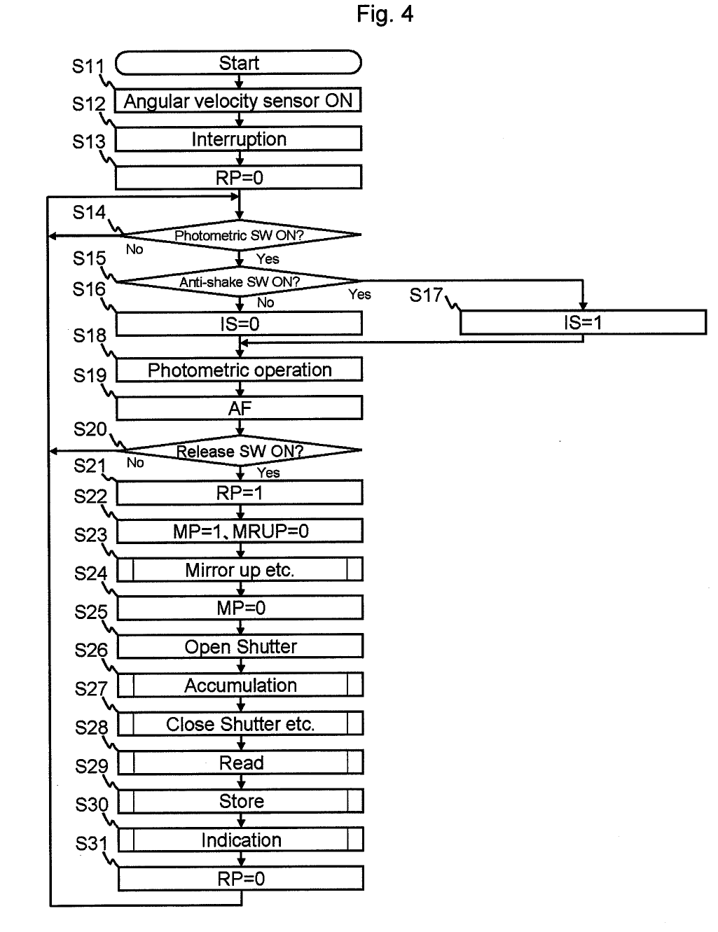

The value of the release state parameter RP changes with respect to the release sequence operation. When the release sequence operation is performed, the value of the release state parameter RP is set to 1 (see steps S21 to S31 in FIG. 4); and when the release sequence operation is finished, the value of the release state parameter RP is set (reset) to 0 (see steps S13 and S31 in FIG. 4).

When the mirror-up operation for the imaging operation is being performed, the value of the mirror state parameter MP is set to 1 (see step S22 in FIG. 4); otherwise, the value of the mirror state parameter MP is set to 0 (see step S24 in FIG. 4).

Whether the mirror-up operation of the photographing apparatus 1 is finished is determined by the detection of the ON/OFF state of the mechanical switch (not depicted). Whether the mirror-down operation of the photographing apparatus 1 is finished is determined by the detection of the completion of the shutter charge.

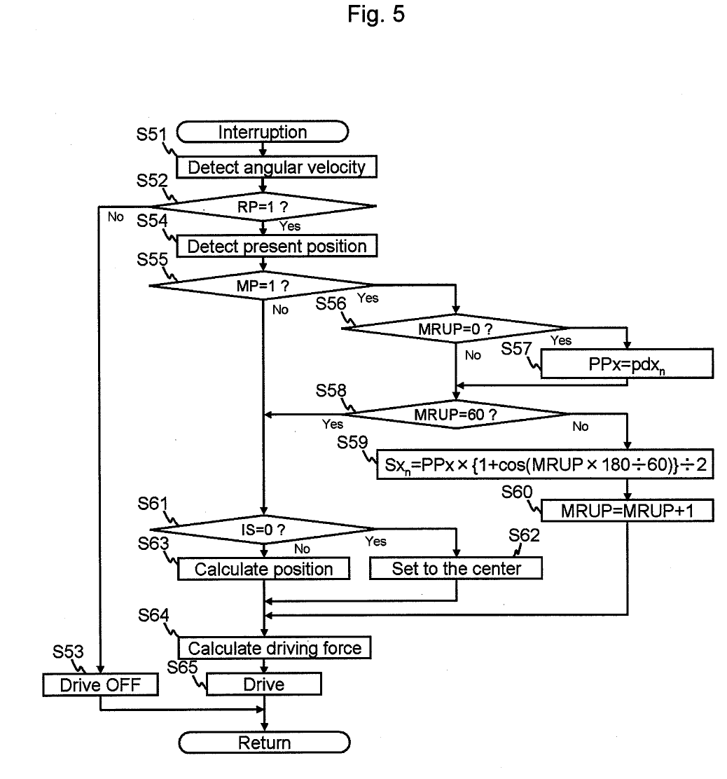

The mirror-up time parameter MRUP is a parameter that measures the length of time while the mirror-up operation is performed (see step S60 in FIG. 5).

The CPU 21 moves the movable unit 30a to the predetermined position in the operation before the anti-shake operation (the centering operation). In the embodiment, the predetermined position is the center of the range of movement (coordinate values in the first direction x and in the second direction y are both 0).

For this movement (this centering operation), the CPU 21 moves the movable unit 30a to the center of the range of movement, taking the full allotment of a predetermined time length (60 ms) to do so after the value of the mirror state parameter MP is set to 1.

After the movable unit 30a has moved to the center of the range of movement, the anti-shake operation commences.

In the centering operation, the movable unit 30a moves at a low speed immediately after starting to move (when the movable unit 30a is close to the start point) and immediately before stopping (when the movable unit 30a is close to the end point, which is the center of the range of movement). In between, the movable unit 30a moves at a high speed.

In other words, the movable unit 30a accelerates after starting to move in the first half of the predetermined time length, and decelerates before finishing its movement in the second half of the predetermined time length. The movable unit 30a stops once the movement is complete.

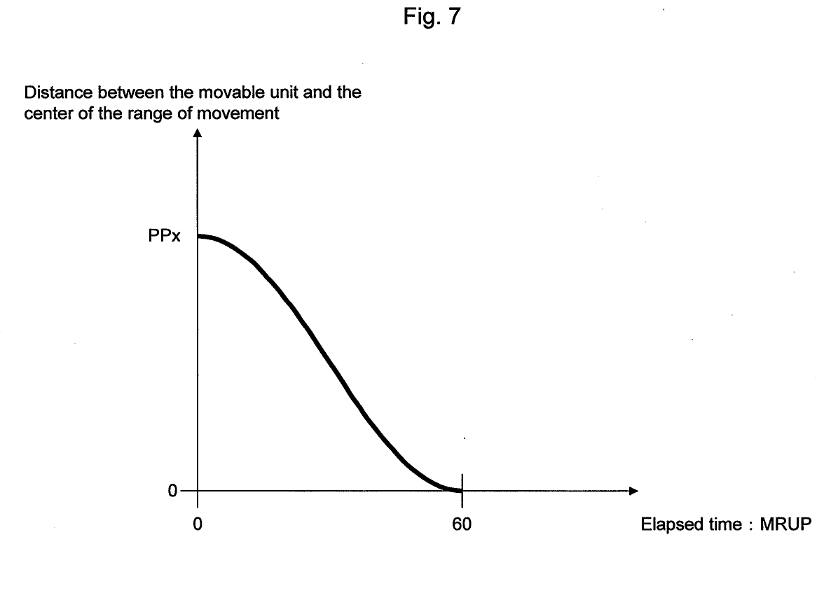

Specifically, the CPU 21 controls the movement of the movable unit 30a, under the condition where the relationship between an elapsed time and a distance between the movable unit 30a and the center of the range of movement is represented by a cosine waveform (see FIG. 7) from the point when the movement of the movable unit 30a commences (MRUP=0 at elapsed time t=0) to the point when the movement of the movable unit 30a terminates (MRUP=60 at elapsed time t=60 ms).

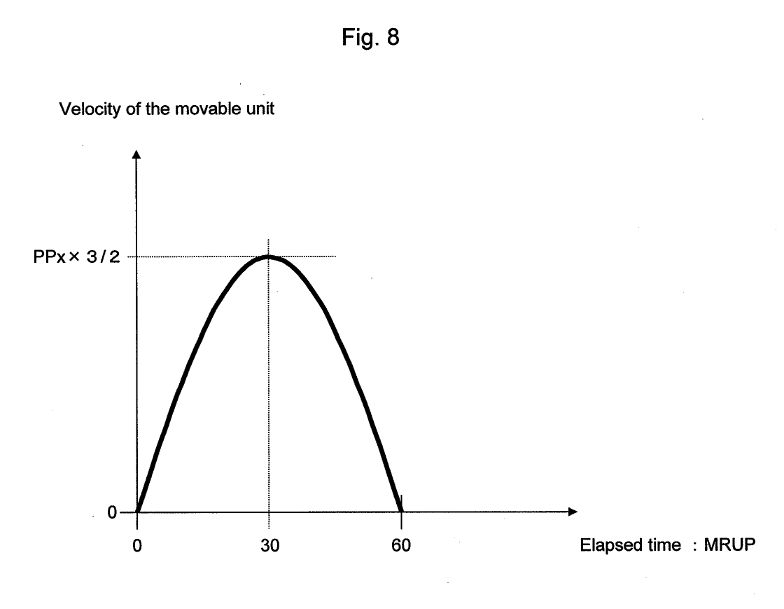

In other words, the CPU 21 controls the movement of the movable unit 30a, under the condition where the relationship between the elapsed time and a movement speed of the movable unit 30a is represented by a sine waveform (see FIG. 8) from the point when the movement of the movable unit 30a commences (MRUP=0, the elapsed time t=0) to the point when the movement of the movable unit 30a terminates (MRUP=60, the elapsed time t=60 ms).

Upon commencement of movement by the movable unit 30a in the centering operation, the first present position parameter PPx is set equal to the position of the movable unit 30a in the first direction x (see step S57 in FIG. 5).

Similarly upon commencement of movement by the movable unit 30a in the centering operation, the second present position parameter PPy is set equal to the position of the movable unit 30a in the second direction y.

Further, the CPU 21 stores values of a first digital angular velocity signal Vxₙ, a second digital angular velocity signal Vyₙ, a first digital angular velocity VVxₙ, a second digital angular velocity VVyₙ, a digital displacement angle Bxₙ, a second digital displacement angle Byₙ, a coordinate of position Sₙ in the first direction x: Sxₙ, a coordinate of position Sₙ in the second direction y: Syₙ, a first driving force Dxₙ, a second driving force Dyₙ, a coordinate of position Pₙ after A/D conversion in the first direction x: pdxₙ, a coordinate of position Pₙ after A/D conversion in the second direction y: pdyₙ, a first subtraction value exₙ, a second subtraction value eyₙ, a first proportional coefficient Kx, a second proportional coefficient Ky, a sampling cycle θ of the anti-shake operation, a first integral coefficient Tix, a second integral coefficient Tiy, a first differential coefficient Tdx, and a second differential coefficient Tdy.

The AE unit (an exposure calculating unit) 23 performs the photometric operation and calculates the photometric values, based on the subject being photographed. The AE unit 23 also calculates the aperture value and the time length of the exposure, with respect to the photometric values, both of which are needed for imaging. The AF unit 24 performs the AF sensing operation and the corresponding focusing operation, both of which are needed for imaging. In the focusing operation, the camera lens 67 is re-positioned along the optical axis in the LX direction.

The anti-shake part (the anti-shake apparatus) of the photographing apparatus 1 comprises an anti-shake button 14, an anti-shake switch 14a, an indicating unit 17, a CPU 21, an angular velocity detection unit 25, a driver circuit 29, an anti-shake unit 30, a hall-element signal-processing unit 45 (a magnetic-field change-detecting element), and the camera lens 67.

When the anti-shake button 14 is depressed by the operator, the anti-shake switch 14a is changed to the ON state so that the anti-shake operation, in which the angular velocity detection unit 25 and the anti-shake unit 30 are driven independently of the other operations which include the photometric operation etc., is carried out at the predetermined time interval. When the anti-shake switch 14a is in the ON state, in other words in the anti-shake mode, the anti-shake parameter IS is set to 1 (IS=1). When the anti-shake switch 14a is not in the ON state, in other words in the non-anti-shake mode, the anti-shake parameter IS is set to 0 (IS=0). In the embodiment, the value of the predetermined time interval is set to 1 ms.

The various output commands corresponding to the input signals of these switches are controlled by the CPU 21.

The information regarding whether the photometric switch 12a is in the ON state or OFF state is input to port P12 of the CPU 21 as a 1-bit digital signal. The information regarding whether the release switch 13a is in the ON state or OFF state is input to port P13 of the CPU 21 as a 1-bit digital signal. The information regarding whether the anti-shake switch 14a is in the ON state or OFF state is input to port P14 of the CPU 21 as a 1-bit digital signal.

The AE unit 23 is connected to port P4 of the CPU 21 for inputting and outputting signals. The AF unit 24 is connected to port P5 of the CPU 21 for inputting and outputting signals. The indicating unit 17 is connected to port P6 of the CPU 21 for inputting and outputting signals.

Next, the details of the input and output relationships between the CPU 21 and the angular velocity detection unit 25, the driver circuit 29, the anti-shake unit 30, and the hall-element signal-processing unit 45 are explained.

The angular velocity detection unit 25 has a first angular velocity sensor 26a, a second angular velocity sensor 26b, a first high-pass filter circuit 27a, a second high-pass filter circuit 27b, a first amplifier 28a and a second amplifier 28b.

The first angular velocity sensor 26a detects the angular velocity of a rotary motion (the yawing) of the photographing apparatus 1 about the axis of the second direction y (the velocity-component in the first direction x of the angular velocity of the photographing apparatus 1). The first angular velocity sensor 26a is a gyro sensor that detects a yawing angular velocity.

The second angular velocity sensor 26b detects the angular velocity of a rotary motion (the pitching) of the photographing apparatus 1 about the axis of the first direction x (detects the velocity-component in the second direction y of the angular velocity of the photographing apparatus 1). The second angular velocity sensor 26b is a gyro sensor that detects a pitching angular velocity.

The first high-pass filter circuit 27a reduces a low frequency component of the signal output from the first angular velocity sensor 26a, because the low frequency component of the signal output from the first angular velocity sensor 26a includes signal elements that are based on a null voltage and a panning-motion, neither of which are related to hand-shake.

The second high-pass filter circuit 27b reduces a low frequency component of the signal output from the second angular velocity sensor 26b, because the low frequency component of the signal output from the second angular velocity sensor 26b includes signal elements that are based on a null voltage and a panning-motion, neither of which are related to hand-shake.

The first amplifier 28a amplifies a signal regarding the yawing angular velocity, whose low frequency component has been reduced, and outputs the analog signal to the A/D converter A/D 0 of the CPU 21 as a first angular velocity vx.

The second amplifier 28b amplifies a signal regarding the pitching angular velocity, whose low frequency component has been reduced, and outputs the analog signal to the A/D converter A/D 1 of the CPU 21 as a second angular velocity vy.

The reduction of the low frequency signal component is a two-step process; the primary part of the analog high-pass filter processing operation is performed first by the first and second high-pass filter circuits 27a and 27b, followed by the secondary part of the digital high-pass filter processing operation that is performed by the CPU 21.

The cut-off frequency of the secondary part of the digital high-pass filter processing operation is higher than that of the primary part of the analog high-pass filter processing operation.

In the digital high-pass filter processing operation, the value of a time constant (a first high-pass filter time constant hx and a second high-pass filter time constant hy) can be easily changed.

The supply of electric power to the CPU 21 and each part of the angular velocity detection unit 25 begins after the PON switch 11a is set to the ON state (the main power supply is set to the ON state). The calculation of a hand-shake quantity begins after the PON switch 11a is set to the ON state.

The CPU 21 converts the first angular velocity vx, which is input to the A/D converter A/D 0, to a first digital angular velocity signal Vxₙ (A/D conversion operation); calculates a first digital angular velocity VVxₙ by reducing a low frequency component of the first digital angular velocity signal Vxₙ (the digital high-pass filter processing operation) because the low frequency component of the first digital angular velocity signal Vxₙ includes signal elements that are based on a null voltage and a panning-motion, neither of which are related to hand-shake; and calculates a hand shake quantity (a hand shake displacement angle: a first digital displacement angle Bxₙ) by integrating the first digital angular velocity VVxₙ (the integration processing operation).

Similarly, the CPU 21 converts the second angular velocity vy, which is input to the A/D converter A/D 1, to a second digital angular velocity signal Vyₙ (A/D conversion operation); calculates a second digital angular velocity VVyₙ by reducing a low frequency component of the second digital angular velocity signal Vyₙ (the digital high-pass filter processing operation) because the low frequency component of the second digital angular velocity signal Vyₙ includes signal elements that are based on a null voltage and a panning-motion, neither of which are related to hand-shake; and calculates a hand shake quantity (a hand shake displacement angle: a second digital displacement angle Byₙ) by integrating the second digital angular velocity VVyₙ (the integration processing operation).

Accordingly, the CPU 21 and the angular velocity detection unit 25 use a function to calculate the hand-shake quantity.

“n” is an integer that is greater than 0, and indicates a length of time (ms) from the point when the interruption process of the timer commences, (t=0, and see step S12 in FIG. 4) to the point when the latest anti-shake operation is performed (t=n).

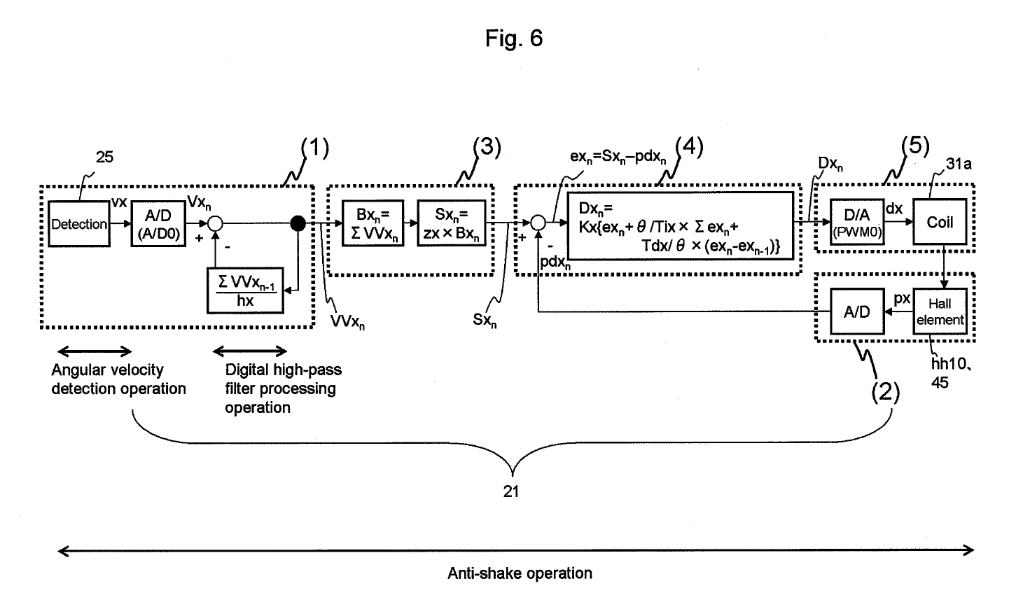

In the digital high-pass filter processing operation regarding the first direction x, the first digital angular velocity VVxₙ is calculated by dividing the summation of the first digital angular velocity VVx₀ to VVxₙ₋₁ calculated by the interruption process of the timer before the 1 ms predetermined time interval (before the latest anti-shake operation is performed), by the first high-pass filter time constant hx, and then subtracting the resulting quotient from the first digital angular velocity signal Vxₙ (VVxₙ=Vxₙ−(ΣVVxₙ₋₁)÷hx, see (1) in FIG. 6).

In the digital high-pass filter processing operation regarding the second direction y, the second digital angular velocity VVyₙ is calculated by dividing the summation of the second digital angular velocity VVy₀ to VVyₙ₋₁ calculated by the interruption process of the timer before the 1 ms predetermined time interval (before the latest anti-shake operation is performed), by the second high-pass filter time constant hy, and then subtracting the resulting quotient from the second digital angular velocity signal Vyₙ (VVyₙ=Vyₙ−(ΣVVyₙ₋₁)÷hy).

In the embodiment, the angular velocity detection operation in (portion of) the interruption process of the timer includes a process in the angular velocity detection unit 25 and a process of inputting process of the first and second angular velocities vx and vy from the angular velocity detection unit 25 to the CPU 21.

In the integration processing operation regarding the first direction x, the first digital displacement angle Bxₙ is calculated by the summation from the first digital angular velocity VVx₀ at the point when the interruption process of the timer commences, t=0, (see step S12 in FIG. 4) to the first digital angular velocity VVxₙ at the point when the latest anti-shake operation is performed (t=n), (Bxₙ=ΣVVxₙ, see (3) in FIG. 6).

Similarly, in the integration processing operation regarding the second direction y, the second digital displacement angle Byₙ is calculated by the summation from the second digital angular velocity VVy₀ at the point when the interruption process of the timer commences to the second digital angular velocity VVyₙ at the point when the latest anti-shake operation is performed (Byₙ=ΣVVyₙ).

The CPU 21 calculates the position Sₙ where the imaging unit 39a (the movable unit 30a) should be moved, corresponding to the hand-shake quantity (the first and second digital displacement angles Bxₙ and Byₙ) calculated for the first direction x and the second direction y, based on a position conversion coefficient zz (a first position conversion coefficient zx for the first direction x and a second position conversion coefficient zy for the second direction y).

The coordinate of position Sₙ in the first direction x is defined as Sxₙ, and the coordinate of position S, in the second direction y is defined as Syₙ. The movement of the movable unit 30a, which includes the imaging unit 39a, is performed by using electromagnetic force and is described later.

The driving force Dₙ drives the driver circuit 29 in order to move the movable unit 30a to the position Sₙ. The coordinate of the driving force Dₙ in the first direction x is defined as the first driving force Dxₙ (after D/A conversion: a first PWM duty dx). The coordinate of the driving force Dₙ in the second direction y is defined as the second driving force Dyₙ (after D/A conversion: a second PWM duty dy).

However, the position Sₙ where the imaging unit 39a (the movable unit 30a) should be moved during a predetermined period having the predetermined time length before the anti-shake operation is performed, is set to a value that does not correspond to the hand-shake quantity, but instead is the center of the range of movement whereto the movable unit is moved over the course of the predetermined period (see step S59 in FIG. 5).

In a positioning operation regarding the first direction x, the coordinate of position Sₙ in the first direction x is defined as Sxₙ, and is the product of the latest first digital displacement angle Bxₙ and the first position conversion coefficient zx (Sxₙ=zx×Bxₙ, see (3) in FIG. 6).

In a positioning operation regarding the second direction y, the coordinate of position Sₙ in the second direction y is defined as Syₙ, and is the product of the latest second digital displacement angle Byₙ and the second position conversion coefficient zy (Syₙ=zy×Byₙ).

The anti-shake unit 30 is an apparatus that corrects for the hand-shake effect by moving the imaging unit 39a to the position Sₙ, by canceling the lag of the photographing subject image on the imaging surface of the imaging device of the imaging unit 39a, and by stabilizing the photographing subject image displayed on the imaging surface of the imaging device during the exposure time when the anti-shake operation is performed (IS=1).

The anti-shake unit 30 has a fixed unit 30b, and a movable unit 30a which includes the imaging unit 39a and can be moved about on the xy plane.

During the exposure time when the anti-shake operation is not performed (IS=0), the movable unit 30a is fixed to (held at) a predetermined position. In the embodiment, the predetermined position is at the center of the range of movement.

During the predetermined period before the exposure time commences, the movable unit 30a is driven (moved) to the center of the range of movement. Otherwise (except for the predetermined period before the exposure time commences and the exposure time), the movable unit 30a is not driven (moved).

The anti-shake unit 30 does not have a fixed-positioning mechanism that maintains the movable unit 30a in a fixed position when the movable unit 30a is not being driven (drive OFF state).

The driving of the movable unit 30a of the anti-shake unit 30, including movement to a predetermined fixed (held) position, is performed by the electro-magnetic force of the coil unit for driving and the magnetic unit for driving, through the driver circuit 29 which has the first PWM duty dx input from the PWM 0 of the CPU 21 and has the second PWM duty dy input from the PWM 1 of the CPU 21 (see (5) in FIG. 6).

The detected-position Pₙ of the movable unit 30a, either before or after the movement effected by the driver circuit 29, is detected by the hall element unit 44a and the hall-element signal-processing unit 45.

Information regarding the first coordinate of the detected-position Pₙ in the first direction x, in other words a first detected-position signal px, is input to the A/D converter A/D 2 of the CPU 21 (see (2) in FIG. 6). The first detected-position signal px is an analog signal that is converted to a digital signal by the A/D converter A/D 2 (A/D conversion operation). The first coordinate of the detected-position Pₙ, in the first direction x, after the A/D conversion operation, is defined as pdxₙ and corresponds to the first detected-position signal px.

Information regarding the second coordinate of the detected-position Pₙ in the second direction y, in other words a second detected-position signal py, is input to the A/D converter A/D 3 of the CPU 21. The second detected-position signal py is an analog signal that is converted to a digital signal by the A/D converter A/D 3 (A/D conversion operation). The second coordinate of the detected-position Pₙ in the second direction y, after the A/D conversion operation, is defined as pdyₙ and corresponds to the second detected-position signal py.

The PID (Proportional Integral Differential) control calculates the first and second driving forces Dxₙ and Dyₙ on the basis of the coordinate data for the detected-position Pₙ (pdxₙ, pdyₙ) and the position Sₙ (Sxₙ, Syₙ) following movement.

The calculation of the first driving force Dxₙ is based on the first subtraction value exₙ, the first proportional coefficient Kx, the sampling cycle θ, the first integral coefficient Tix, and the first differential coefficient Tdx (Dxₙ=Kx×{exₙ+θ÷Tix×Σexₙ+Tdx÷θ×(exₙ−exₙ₋₁)}, see (4) in FIG. 6). The first subtraction value exₙ is calculated by subtracting the first coordinate of the detected-position Pₙ in the first direction x after the A/D conversion operation, pdxₙ, from the coordinate of position Sₙ in the first direction x, Sxₙ (exₙ=Sxₙ−pdxₙ).

The calculation of the second driving force Dyₙ is based on the second subtraction value eyₙ, the second proportional coefficient Ky, the sampling cycle θ, the second integral coefficient Tiy, and the second differential coefficient Tdy (Dyₙ=Ky×{eyₙ+θ÷Tiy×Σeyₙ+Tdy÷θ×(eyₙ−eyₙ₋₁)}) . The second subtraction value eyₙ is calculated by subtracting the second coordinate of the detected-position Pₙ in the second direction y after the A/D conversion operation, pdyₙ, from the coordinate of position Sₙ in the second direction y, Syₙ (eyₙ=Syₙ−pdyₙ).

The value of the sampling cycle θ is set to a predetermined time interval of 1 ms.

Driving the movable unit 30a to the position Sₙ, (Sxₙ,Syₙ) corresponding to the anti-shake operation of the PID control, is performed when the photographing apparatus 1 is in the anti-shake mode (IS=1) where the anti-shake switch 14a is set to the ON state.

When the anti-shake parameter IS is 0, the PID control that does not correspond to the anti-shake operation is performed so that the movable unit 30a is moved to the center of the range of movement (the predetermined position).

The movable unit 30a has a coil unit for driving that is comprised of a first driving coil 31a and a second driving coil 32a, an imaging unit 39a that has the imaging device, and a hall element unit 44a as a magnetic-field change-detecting element unit. In the embodiment, the imaging device is a CCD; however, the imaging device may be another imaging device such as a CMOS etc.

The fixed unit 30b has a magnetic unit for driving that is comprised of a first position-detecting and driving magnet 411b, a second position-detecting and driving magnet 412b, a first position-detecting and driving yoke 431b, and a second position-detecting and driving yoke 432b.

The fixed unit 30b movably supports the movable unit 30a in the first direction x and in the second direction y.

When the center area of the imaging device is intersected by the optical axis LX of the camera lens 67, the relationship between the position of the movable unit 30a and the position of the fixed unit 30b is arranged so that the movable unit 30a is positioned at the center of its range of movement in both the first direction x and the second direction y, in order to utilize the full size of the imaging range of the imaging device.

A rectangle shape, which is the form of the imaging surface of the imaging device, has two diagonal lines. In the first embodiment, the center of the imaging device is at the intersection of these two diagonal lines.

The first driving coil 31a, the second driving coil 32a, and the hall element unit 44a are attached to the movable unit 30a.

The first driving coil 31a forms a seat and a spiral shaped coil pattern. The coil pattern of the first driving coil 31a has lines which are parallel to the second direction y, thus creating the first electro-magnetic force to move the movable unit 30a that includes the first driving coil 31a, in the first direction x.

The first electro-magnetic force occurs on the basis of the current direction of the first driving coil 31a and the magnetic-field direction of the first position-detecting and driving magnet 411b.

The second driving coil 32a forms a seat and a spiral shaped coil pattern. The coil pattern of the second driving coil 32a has lines which are parallel to the first direction x, thus creating the second electromagnetic force to move the movable unit 30a that includes the second driving coil 32a, in the second direction y.

The second electro-magnetic force occurs on the basis of the current direction of the second driving coil 32a and the magnetic-field direction of the second position-detecting and driving magnet 412b.

The first and second driving coils 31a and 32a are connected to the driver circuit 29, which drives the first and second driving coils 31a and 32a, through the flexible circuit board (not depicted). The first PWM duty dx is input to the driver circuit 29 from the PWM 0 of the CPU 21, and the second PWM duty dy is input to the driver circuit 29 from the PWM 1 of the CPU 21. The driver circuit 29 supplies power to the first driving coil 31a that corresponds to the value of the first PWM duty dx, and to the second driving coil 32a that corresponds to the value of the second PWM duty dy, to drive the movable unit 30a.

The first position-detecting and driving magnet 411b is attached to the movable unit side of the fixed unit 30b, where the first position-detecting and driving magnet 411b faces the first driving coil 31a and the horizontal hall element hh10 in the third direction z.

The second position-detecting and driving magnet 412b is attached to the movable unit side of the fixed unit 30b, where the second position-detecting and driving magnet 412b faces the second driving coil 32a and the vertical hall element hv10 in the third direction z.

The first position-detecting and driving magnet 411b is attached to the first position-detecting and driving yoke 431b, under the condition where the N pole and S pole are arranged in the first direction x. The first position-detecting and driving yoke 431b is attached to the fixed unit 30b on the side of the movable unit 30a in the third direction z.

The second position-detecting and driving magnet 412b is attached to the second position-detecting and driving yoke 432b, under the condition where the N pole and S pole are arranged in the second direction y. The second position-detecting and driving yoke 432b is attached to the fixed unit 30b on the side of the movable unit 30a in the third direction z.

The first and second position-detecting and driving yokes 431b, 432b are made of a soft magnetic material.

The first position-detecting and driving yoke 431b prevents the magnetic-field of the first position-detecting and driving magnet 411b from dissipating to the surroundings, and raises the magnetic-flux density between the first position-detecting and driving magnet 411b and the first driving coil 31a, and between the first position-detecting and driving magnet 411b and the horizontal hall element hh10.

The second position-detecting and driving yoke 432b prevents the magnetic-field of the second position-detecting and driving magnet 412b from dissipating to the surroundings, and raises the magnetic-flux density between the second position-detecting and driving magnet 412b and the second driving coil 32a, and between the second position-detecting and driving magnet 412b and the vertical hall element hv10.

The hall element unit 44a is a single-axis unit that contains two magnetoelectric converting elements (magnetic-field change-detecting elements) utilizing the Hall Effect to detect the first detected-position signal px and the second detected-position signal py specifying the first coordinate in the first direction x and the second coordinate in the second direction y, respectively, of the present position Pₙ of the movable unit 30a.

One of the two hall elements is a horizontal hall element hh10 for detecting the first coordinate of the position Pₙ of the movable unit 30a in the first direction x, and the other is a vertical hall element hv10 for detecting the second coordinate of the position Pₙ of the movable unit 30a in the second direction y.

The horizontal hall element hh10 is attached to the movable unit 30a, where the horizontal hall element hh10 faces the first position-detecting and driving magnet 411b of the fixed unit 30b in the third direction z.

The vertical hall element hv10 is attached to the movable unit 30a, where the vertical hall element hv10 faces the second position-detecting and driving magnet 412b of the fixed unit 30b in the third direction z.

When the center of the imaging device intersects the optical axis LX, it is desirable to have the horizontal hall element hh10 positioned on the hall element unit 44a facing an intermediate area between the N pole and S pole of the first position-detecting and driving magnet 411b in the first direction x, as viewed from the third direction z. In this position, the horizontal hall element hh10 utilizes the maximum range in which an accurate position-detecting operation can be performed based on the linear output-change (linearity) of the single-axis hall element.

Similarly, when the center of the imaging device intersects the optical axis LX, it is desirable to have the vertical hall element hv10 positioned on the hall element unit 44a facing an intermediate area between the N pole and S pole of the second position-detecting and driving magnet 412b in the second direction y, as viewed from the third direction z.

The hall-element signal-processing unit 45 has a first hall-element signal-processing circuit 450 and a second hall-element signal-processing circuit 460.

The first hall-element signal-processing circuit 450 detects a horizontal potential-difference x10 between the output terminals of the horizontal hall element hh10 that is based on an output signal of the horizontal hall element hh10.

The first hall-element signal-processing circuit 450 outputs the first detected-position signal px, which specifies the first coordinate of the position Pₙ of the movable unit 30a in the first direction x, to the A/D converter A/D 2 of the CPU 21, on the basis of the horizontal potential-difference x10.

The second hall-element signal-processing circuit 460 detects a vertical potential-difference y10 between the output terminals of the vertical hall element hv10 that is based on an output signal of the vertical hall element hv10.

The second hall-element signal-processing circuit 460 outputs the second detected-position signal py, which specifies the second coordinate of the position Pₙ of the movable unit 30a in the second direction y, to the A/D converter A/D 3 of the CPU 21, on the basis of the vertical potential-difference y10.

Next, the main operation of the photographing apparatus 1 is explained by using the flowchart in FIG. 4.

When the photographing apparatus 1 is set to the ON state, the electrical power is supplied to the angular velocity detection unit 25 so that the angular velocity detection unit 25 is set to the ON state in step S11.

In step S12, the interruption process of the timer at the predetermined time interval (1 ms) commences. In step S13, the value of the release state parameter RP is set to 0. The detail of the interruption process of the timer is explained later by using the flowchart in FIG. 5.

In step S14, it is determined whether the photometric switch 12a is set to the ON state. When it is determined that the photometric switch 12a is not set to the ON state, the operation returns to step S14 and the process in step S14 is repeated. Otherwise, the operation continues on to step S15.

In step S15, it is determined whether the anti-shake switch 14a is set to the ON state. When it is determined that the anti-shake switch 14a is not set to the ON state, the value of the anti-shake parameter IS is set to 0 in step S16. Otherwise, the value of the anti-shake parameter IS is set to 1 in step S17.

In step S18, the AE sensor of the AE unit 23 is driven, the photometric operation is performed, and the aperture value and exposure time are calculated.

In step S19, the AF sensor and the lens control circuit of the AF unit 24 are driven to perform the AF sensing and focus operations, respectively.

In step S20, it is determined whether the release switch 13a is set to the ON state. When the release switch 13a is not set to the ON state, the operation returns to step S14 and the process in steps S14 to S19 is repeated. Otherwise, the operation continues on to step S21 and the release sequence operation commences.

Instep S21, the value of the release state parameter RP is set to 1. In step S22, the value of the mirror state parameter MP is set to 1 and the value of the mirror-up time parameter MRUP is set to 0.

In step S23, the mirror-up operation and the aperture closing operation corresponding to the aperture value that is either preset or calculated, are performed by the mirror-aperture-shutter unit 18.

After the mirror-up operation is finished, the value of the mirror state parameter MP is set to 0, in step S24. In step S25, the opening operation of the shutter (the movement of the front curtain in the shutter) commences.

The length of time from the point when the mirror-up operation commences in step S23 to the point when the opening operation of the shutter commences in step S25 is approximately 70 ms. Therefore, before the opening operation of the shutter commences, the predetermined time length (60 ms) elapses, in other words the movement of the movable unit 30a to the predetermined position (the center of the range of movement) finishes.

In step S26, the exposure operation, or in other words the electric charge accumulation of the imaging device (CCD etc.), is performed. After the exposure time has elapsed, the closing operation of the shutter (the movement of the rear curtain in the shutter), the mirror-down operation, and the opening operation of the aperture are performed by the mirror-aperture-shutter unit 18 in step S27.

In step S28, the electric charge which has accumulated in the imaging device during the exposure time is read. In step S29, the CPU 21 communicates with the DSP 19 so that the image processing operation is performed based on the electric charge read from the imaging device. The image, on which the image processing operation is performed, is stored to the memory in the photographing apparatus 1. In step S30, the image that is stored in the memory is displayed on the indicating unit 17. In step S31, the value of the release state parameter RP is set to 0 so that the release sequence operation is finished, and the operation then returns to step S14, in other words the photographing apparatus 1 is set to a state where the next imaging operation can be performed.

Next, the interruption process of the timer, which commences in step S12 in FIG. 4 and is performed at every predetermined time interval (1 ms) independent of the other operations, is explained by using the flowchart in FIG. 5.

When the interruption process of the timer commences, the first angular velocity vx, which is output from the angular velocity detection unit 25, is input to the A/D converter A/D 0 of the CPU 21 and converted to the first digital angular velocity signal Vxₙ, in step S51. The second angular velocity vy, which is also output from the angular velocity detection unit 25, is input to the A/D converter A/D 1 of the CPU 21 and converted to the second digital angular velocity signal Vyₙ (the angular velocity detection operation).

The low frequencies of the first and second digital angular velocity signals Vxₙ and Vyₙ are reduced in the digital high-pass filter processing operation (the first and second digital angular velocities VVxₙ and VVyₙ).

In step S52, it is determined whether the value of the release state parameter RP is set to 1. When it is determined that the value of the release state parameter RP is not set to 1, driving the movable unit 30a is set to OFF state or the anti-shake unit 30 is set to a state where the driving control of the movable unit 30a is not performed in step S53. Otherwise, the operation proceeds directly to step S54.

In step S54, the hall element unit 44a detects the position of the movable unit 30a, and the first and second detected-position signals px and py are calculated by the hall-element signal-processing unit 45. The first detected-position signal px is then input to the A/D converter A/D 2 of the CPU 21 and converted to a digital signal pdxₙ, whereas the second detected-position signal py is input to the A/D converter A/D 3 of the CPU 21 and also converted to a digital signal pdyₙ, both of which thus determine the present position Pₙ (pdxₙ, pdyₙ) of the movable unit 30a.

In step S55, it is determined whether the value of the mirror state parameter MP is set to 1. When it is determined that the value of the mirror state parameter MP is not set to 1, the operation proceeds directly to step S61; otherwise, the operation continues to step S56.

In step S56, it is determined whether the value of the mirror-up time parameter MRUP is set to 0.

When it is determined that the value of the mirror-up time parameter MRUP is set to 0, the value of the first present position parameter PPx is set to the value of the coordinate of the position Pₙ l in the first direction x after A/D conversion, pdxₙ, and the value of the second present position parameter PPy is set to the value of the coordinate of the position Pₙ after A/D conversion in the second direction y after A/D conversion, pdyₙ, in step S57. Then the operation continues step S58. When it is determined that the value of the mirror-up time parameter MRUP is not set to 0, the operation proceeds directly to step S58.

In step S58, it is determined whether the value of the mirror-up time parameter MRUP is set to 60.

When it is determined that the value of the mirror-up time parameter MRUP is set to 60, the operation proceeds directly to step S61; otherwise, the operation continues to step S59.

In step S59, the position Sₙ (Sxₙ, Syₙ) where the movable unit 30a (the imaging unit 39a) should be moved is calculated on the basis of the first and second present position parameters PPx and PPy, and the mirror-up time parameter MRUP (Sxₙ=PPx×{1+cos (MRUP×180 degrees÷60)÷2, Syₙ=PPy×{1+cos (MRUP×180 degrees÷60)÷2) .

In step S60, the mirror-up time parameter MRUP is increased by the value of 1, then the operation proceeds directly to step S64.

Because a large load is exerted upon the CPU 21 when it performs the trigonometric function processing operation to calculate the value of “cos(MRUP×180 degrees ÷60)”, it is desirable to store the values of the 61 different patterns of “cos (MRUP×180 degrees+60)” from when the MRUP=0 to when MRUP=60, in order to increase the processing speed.

In step S61, it is determined whether the value of the anti-shake parameter IS is 0. When it is determined that the value of the anti-shake parameter IS is 0 (IS=0), in other words when the photographing apparatus is not in anti-shake mode, the position Sₙ (Sxₙ, Syₙ) where the movable unit 30a (the imaging unit 39a) should be moved is set at the center of the range of movement of the movable unit 30a, in step S62. When it is determined that the value of the anti-shake parameter IS is not 0 (IS=1), in other words when the photographing apparatus is in anti-shake mode, the position Sₙ (Sxₙ, Syₙ) where the movable unit 30a (the imaging unit 39a) should be moved is calculated on the basis of the first and second angular velocities vx and vy, in step S63.

In step S64, the first driving force Dxₙ (the first PWM duty dx) and the second driving force Dyₙ (the second PWM duty dy) of the driving force Dₙ which moves the movable unit 30a to the position Sₙ, are calculated on the basis of the position Sₙ (Sxₙ, Syₙ) that was determined in step S59, step S62 or step S63, and the present position Pₙ (pdxₙ, pdyₙ).

In step S65, the first driving coil unit 31a is driven by applying the first PWM duty dx to the driver circuit 29, and the second driving coil unit 32a is driven by applying the second PWM duty dy to the driver circuit 29, so that the movable unit 30a is moved to position Sₙ (Sxₙ, Syₙ).

The process of steps S64 and S65 is an automatic control calculation that is used with the PID automatic control for performing general (normal) proportional, integral, and differential calculations.

The centering operation is performed, in other words the movable unit 30a is moved and fixed to (held at) the center of the range of movement, before the anti-shake operation commences (before step S61 in FIG. 5). Next, the anti-shake operation commences.

In the case where the movable unit 30a is moved at a high rate of speed in the centering operation that is as great as that in the anti-shake operation, the movement of the movable 30a includes swing and may not be stabilized.

Further, the shock resulting from the movement of the movable unit 30a is transmitted to the operator supporting the photographing apparatus 1, which may cause irritation for the operator.

In the embodiment, because it takes 60 ms to move the movable unit 30a from the point when the value of the mirror-up time parameter MRUP is set to 0, the movement is slow compared to that of the anti-shake operation (see FIG. 7).

In particular, immediately before finishing movement (when the movable unit 30a approaches the point of destination (the center of the range of movement)), the movable unit 30a is moved at a low speed so that the movable unit 30a is not suddenly stopped when it reaches the center of the range of movement (gradually stopped).

Therefore, the swinging movement of the movable unit 30a based on the sudden breaking operation is restrained so that the corresponding shock (the breaking shock) can also be restrained.

Further, immediately after the movable unit 30a starts to move (when the movable unit 30a is near the start point), the movable unit 30a is moved at a low rate of speed. Therefore, the movable unit 30a is not suddenly moved (gradually moved) from the initial state of rest. Accordingly, the swinging movement of the movable unit 30a based on a sudden start is restrained.

In the embodiment, the CPU 21 controls the movement of the movable unit 30a under the condition where the relationship between an elapsed time and a distance between the movable unit 30a and the center of the range of movement is represented by a cosine waveform (see FIG. 7) from the point when the movement of the movable unit 30a commences (MRUP=0, the elapsed time t=0) to the point when the movement of the movable unit 30a is finished (MRUP=60, the elapsed time t=60 ms), before the anti-shake operation.

In other words, the CPU 21 controls the movement of the movable unit 30a under the condition where the relationship between the elapsed time and a movement speed of the movable unit 30a is represented by a sine waveform (see FIG. 8) from the point when the movement of the movable unit 30a commences (MRUP=0, the elapsed time t=0) to the point when the movement of the movable unit 30a is finished (MRUP=60, the elapsed time t=60 ms), before the anti-shake operation.

However, the waveform that represents the relationship between an elapsed time and a distance between the movable unit 30a and the center of the range of movement, is not limited to the cosine waveform.

For example, the waveform that represents the relationship between an elapsed time and a distance between the movable unit 30a and the center of the range of movement may be a saturation curve that the movement of the movable unit 30a follows at a low speed immediately before the movement of the movable unit 30a is finished (MRUP=60).

Further, in the embodiment, the photographing apparatus 1 is a single lens reflex camera that performs the mirror-up operation; however, the photographing apparatus 1 may not perform the mirror-up operation.

In the case where the photographing apparatus 1 that does not perform the mirror-up operation is used for the embodiment, the centering operation is complete before the electric charge accumulation of the imaging device for exposure (the point in time corresponding to the beginning of the time of exposure). Further, the anti-shake operation may be performed, except during the exposure time.

Further, the length of the predetermined time length is not limited to 60 ms. The predetermined time length is set to a time length that is shorter than the length of time from the point when the release switch 13a is set to the ON state to the point when the electric charge accumulation of the imaging device for exposure commences. Therefore, the predetermined time length needs only to have elapsed (the predetermined period is finished) prior to the commencement of the electric charge accumulation of the imaging device.

In the embodiment, the predetermined time length is set to 60 ms, which is shorter than the length of time (approximately 70 ms) from the point when the mirror-up operation commences after the release switch 13a has been set to the ON state (see step S23 in FIG. 4) to the point when the opening operation of the shutter commences prior to the exposure time (see step S25 in FIG. 4). Further, the predetermined time length elapses (the predetermined period is finished) before the electric charge accumulation of the imaging device for exposure commences and before the opening operation of the shutter.

Further, it is explained that the movable unit 30a has the imaging device. However, the movable unit 30a may have a hand-shake correcting lens instead of the imaging device.

Further, it is explained that the hall element is used for position detection as the magnetic-field change-detecting element. However, another detection element, an MI (Magnetic Impedance) sensor such as a high-frequency carrier-type magnetic-field sensor, a magnetic resonance-type magnetic-field detecting element, or an MR (Magneto-Resistance effect) element may be used for position detection purposes. When one of either the MI sensor, the magnetic resonance-type magnetic-field detecting element, or the MR element is used, the information regarding the position of the movable unit can be obtained by detecting the magnetic-field change, similar to using the hall element.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2006-192353 (filed on Jul. 13, 2006), which is expressly incorporated herein by reference, in its entirety.

1. An anti-shake apparatus for image stabilizing, comprising:
a movable unit that is movable for an anti-shake operation; and
a controller that moves said movable unit to a predetermined position over the course of a predetermined time length before said anti-shake operation commences;
said controller moving said movable unit at a decelerated, low rate of speed before finishing its movement to said predetermined position, said anti-shake operation being performed after completion of the movement to said predetermined position.

2. The anti-shake apparatus according to claim 1, wherein said predetermined position is at the center of the range of movement of said movable unit.

3. The anti-shake apparatus according to claim 1, wherein said movable unit is configured to finish its movement to said predetermined position before an exposure commences.

4. The anti-shake apparatus according to claim 1, further comprising:
a mirror that performs a mirror-up operation; and
a shutter;
said predetermined time length being shorter than a time length from a point when said mirror-up operation commences after a release switch is set to an ON state to a point when an opening operation of said shutter commences; and
a movement of said movable unit to said predetermined position being completed before said opening operation of said shutter commences.

5. The anti-shake apparatus according to claim 1, wherein said controller accelerates a movement of said movable unit immediately after starting to move said movable unit to said predetermined position.

6. The anti-shake apparatus according to claim 5, wherein said controller controls the movement of said movable unit under a condition where a relationship between an elapsed time from the starting point of a predetermined period having said predetermined time length and a distance between said movable unit and the center of the range of movement is represented by a cosine waveform.

7. The anti-shake apparatus according to claim 6, wherein the movement control of said movable unit for said anti-shake operation and the movement control of said movable unit to said predetermined position are performed at a predetermined time interval; and
said predetermined time length is longer than said predetermined time interval.

8. An anti-shake apparatus for image stabilizing, comprising:
a movable unit that is movable for an anti-shake operation; and
a controller that moves said movable unit from a first position to a second position where said anti-shake operation commences over the course of a predetermined time length;
said movable unit decelerating in a second half of said predetermined time length.

9. The anti-shake apparatus according to claim 8, wherein said movable unit accelerates in a first half of said predetermined time length.
